(19) United States
(12) Patent Application Publication
(10) Pub. No.: US 2011/0169747 A1
(43) Pub. Date: Jul. 14, 2011

(54) Touch Detection Method

(75) Inventors: Chen-Ming CHEN, Hsin-Chu (TW); Pang-Chiang Chia, Hsin-Chu (TW)

(73) Assignee: AU Optronics Corp.

(21) Appl. No.: 12/684,915

(22) Filed: Jan. 9, 2010

(51) Int. Cl. G06F 3/041

(52) U.S. Cl. 345/173

(57) ABSTRACT

A touch detection method is adapted for a display apparatus. The display apparatus comprises a first gate line, a sensor pad and a second gate line adjacent to the first gate line. The sensor pad is electrically coupled to the first gate line. The touch detection method comprises steps of: enabling the first gate line; and detecting whether the sensor pad is touched before enabling the second gate line. Therein, a partial overlapped time exists between a subsequent enable period for enabling the second gate line and an enable period for enabling the first gate line.

### CROSS-REFERENCE TO RELATED APPLICATIONS

This application is based upon and claims the benefit of priority from the prior Taiwanese Patent Application No. 098106584, filed Feb. 27, 2009, the entire contents of which are incorporated herein by reference.

### BACKGROUND

1. Field of the Invention

The present invention relates to a field of touch detection, and more particularly to a touch detection method.

2. Description of the Related Art

Refer to FIGS. 1 to 3, wherein FIG. 1 illustrates a timing chart of signals in a plurality of gate lines GL2m−1, GL2m and GL2m+1 of a conventional display apparatus with a touch function, FIG. 2 illustrates an equivalent-circuit diagram of a sense line SL and a detection circuit electrically coupled to the gate line GL2m, and FIG. 3 illustrates charging and discharging processes of the sense line SL.

As shown in FIG. 2, the gate line GL2m is electrically coupled to a gate electrode of a thin film transistor (TFT) Q2, a drain electrode of the TFT Q2 is electrically coupled to the sense line SL, and a source electrode of the TFT Q2 is electrically coupled to a sensor pad SP. A parasitic capacitance C is formed between the sense line SL and a common voltage Vcom, and the sensor pad SP is touched to be electrically coupled to the common voltage Vcom. The detection circuit (not marked in FIG. 2) includes a comparator (not marked in FIG. 2), a reference supply Vref1 electrically coupled between a negative input terminal of the comparator and the common voltage Vcom, and another reference supply Vref2 electrically coupled between a positive input terminal of the comparator and the common voltage Vcom. The negative input terminal of the comparator is electrically coupled to the sense line SL.

Referring to FIGS. 1 and 3 together, enable pulse widths of the signals in the gate lines GL2m−1, GL2m, and GL2m+1 are a scan line time (1H) respectively. In an enable period T1 for enabling the gate line GL2m−1, the TFT Q2 electrically coupled to the gate line GL2m is still turned off, and the reference supply Vref1 charges the sense line SL to a potential of Vref1. In other words, the sense line SL is charged in the enable period T1 for enabling the previous gate line GL2m−1 before the gate line GL2m electrically coupled thereto. At the moment, even if the sensor pad SP is touched to be electrically coupled to the common voltage Vcom, the sense line still keeps the potential of Vref1.

In an enable period T2 for enabling the gate line GL2m, the TFT Q2 electrically coupled to the gate line GL2m is turned on. At the moment, if the sensor pad SP is touched to be electrically coupled to the common voltage Vcom, the sense line SL is discharged to achieve a potential of the common voltage Vcom. Since the potential of Vcom at the negative input terminal is less than the potential of Vref2 at the positive input terminal at the moment, the comparator of the detection circuit can detect the sensor pad SP is touched, such that the touch detection operation is completed.

In some designs for the display apparatus with the touch function, since an area of a frame of a panel (particularly to a narrow frame with small and medium sizes) is small, a gate-on-array (GOA) circuit is manufactured to be driven by a bilateral-gate mode to reduce the area of the whole circuit. For example, odd gate lines such as GL2m−1, GL2m+1 and so on, are enabled by the gate circuit on the left array, and even gate lines such as GL2m and so on, are enabled by the gate circuit on the right array. To achieve a better drive result, the sequence of the enable pulses of the gate lines generally represents that the enable pulse of the previous gate line overlaps a scan line time with the enable pulse of the following gate line, and the enable pulse width of each of the gate line is two scan line time. That is, a real-opening time of the gate line GL2m−1 overlaps with a pre-opening time of the gate line GL2m, and so on.

Obviously, in the condition of the enable pulses of the two adjacent gate lines including an overlapped scan line time, if the sense line SL is charged in the real-opening time of the gate line GL2m−1, the TFT Q2 is turned on since it is also the pre-opening time of the gate line GL2m. If the sensor pad SP is touched to be electrically coupled to the common voltage Vcom at the moment, the sense line SL will always leak the current and cannot be charged to the potential of Vref1, such that the detection circuit cannot rightly compare the potential difference to judge whether the sensor pad SP is touched.

### BRIEF SUMMARY

The present invention relates to a touch detection method adapted for a display apparatus having a partial overlapped time in enable pluses of two adjacent gate lines.

A touch detection method in accordance with an exemplary embodiment of the present invention is adapted for a display apparatus. The display apparatus comprises a first gate line, a sensor pad and a second gate line adjacent to the first gate line. The sensor pad is electrically coupled to the first gate line. The touch detection method comprises steps of: enabling the first gate line; and detecting whether the sensor pad is touched before enabling the second gate line. Therein, a subsequent enable period (that is, an enable pulse width) for enabling the second gate line and an enable period for enabling the first gate line are overlapped for a partial overlapped time.

In an exemplary embodiment of the present invention, the partial overlapped time is a half of the enable period for enabling the first gate line.

In an exemplary embodiment of the present invention, the enable period for enabling the first gate line comprises a pre-opening time and a real-opening time. The pre-opening time is before the real-opening time, and the step of detecting whether the sensor pad is performed in the pre-opening time of the enable period for enabling the first gate line. Furthermore, the pre-opening time is equal to the real-opening time, and the first gate line is enabled by performing a potential pull-up operation.

A touch detection method in accordance with another exemplary embodiment of the present invention is adapted for a display apparatus. The display apparatus comprises a first gate line, a second gate line adjacent to the first gate line, and a sensor pad. The sensor pad is electrically coupled to the second gate line. The touch detection method comprises steps of: enabling the first gate line and the second gate line in sequence, wherein an enable period for enabling the second gate line and another enable period for enabling the first gate line are overlapped for a partial overlapped time; and detecting whether the sensor pad is touched in the partial overlapped time for enabling both of the first gate line and the second gate line.

A touch detection method in accordance with other exemplary embodiment of the present invention is adapted for a display apparatus. The display apparatus comprises a first gate line, a second gate line, a third gate line and a sense line. The second gate line is adjacent to the first gate line and the third gate line and is arranged between the first gate line and the third gate line. The sense line is electrically coupled to the second gate line and is not electrically coupled to the first gate line and the third gate line. The touch detection method comprises steps of: enabling the first gate line, the second gate line and the third gate line in sequence, wherein a first partial overlapped time exists between a first enable period for enabling the first gate line and a second enable period for enabling the second gate line, and a second partial overlapped time exists between a third enable period for enabling the third gate line and the second enable period for enabling the second gate line; performing a charging operation to the sense line before the second enable period for enabling the second gate line; and performing a detection operation to the sense line in the second enable period for enabling the second gate line and before changing statuses of the first gate line and the third gate line.

In an exemplary embodiment of the present invention, the detection operation is performed in the first overlapped time for enabling both of the second gate line and the first gate line.

In an exemplary embodiment of the present invention, the detection operation is performed in the second enable period for enabling the second gate line and before the third enable period for enabling the third gate line.

The above exemplary embodiment of the present invention performs the detection operation in the real-opening time of the previous gate line before the gate line electrically coupled to the sensor pad/the sense line, and/or before the enable period for enabling the next gate line thereafter, so as to perform the charging operation before the enable period for enabling the gate line electrically coupled to the sensor pad/the sense line correspondingly. Thus the charging operation to the sense line is not influenced by the touch operation. Therefore, the touch detection method of the above exemplary embodiment of the present invention can be adapted for a display apparatus having the partial overlapped time in the enable pulses of the two adjacent gate lines.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a timing chart of signals in a plurality of gate lines of a conventional display apparatus with a touch function.

FIG. 2 is an equivalent-circuit diagram of a sense line and a detection circuit electrically coupled to the gate line as shown in FIG. 1.

FIG. 3 illustrates charging and discharging processes of the sense line as shown in FIG. 2.

FIG. 4 is a partial circuit diagram of a display apparatus with a touch function in accordance with an exemplary embodiment of the present invention.

FIG. 5 is an equivalent-circuit diagram of a sense line as shown in FIG. 4 and a detection circuit.

FIG. 6 is a timing chart of signals in a plurality of gate lines and a sense line as shown in FIG. 4.

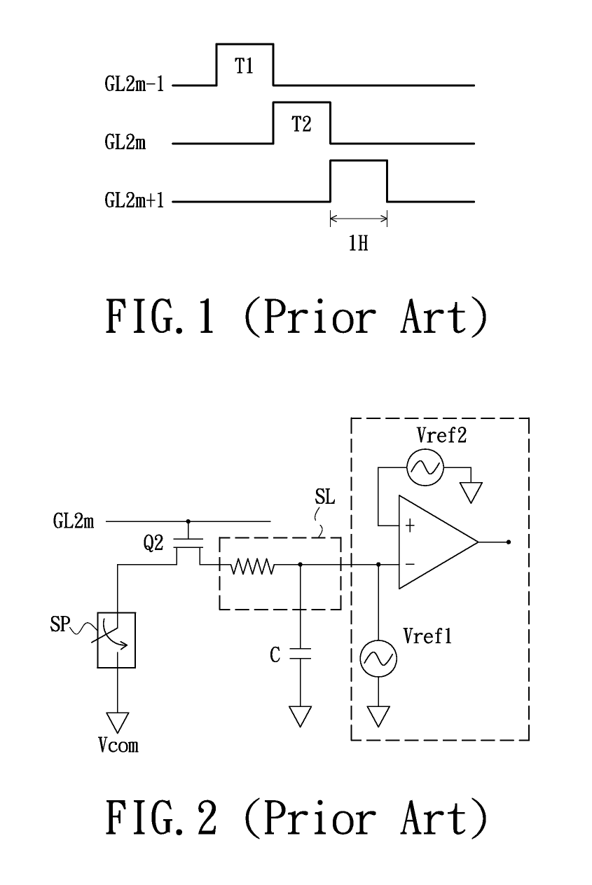

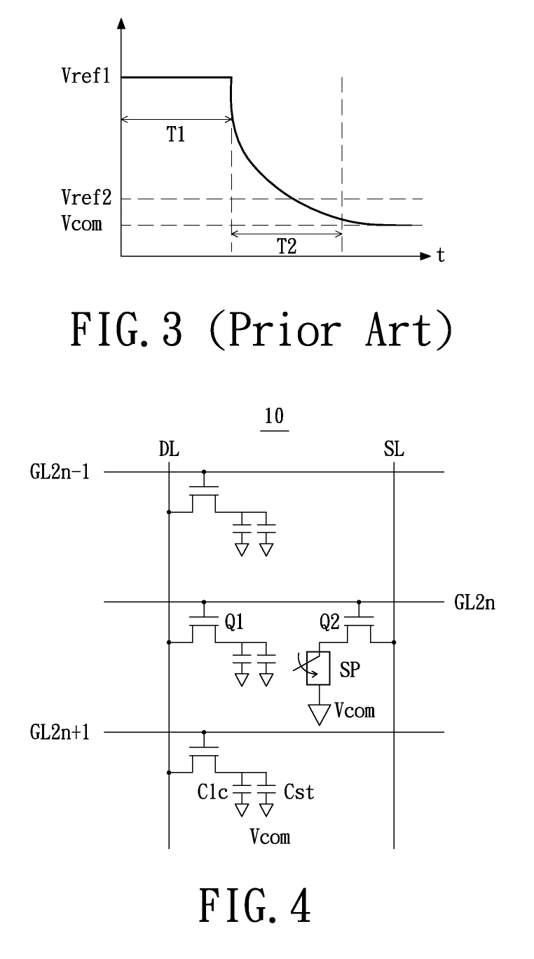

### DETAILED DESCRIPTION

Reference will now be made to the drawings to describe exemplary embodiments of the present touch detection method, in detail. The following description is given by way of example, and not limitation.

The following description will describe a touch detection method in accordance with an exemplary embodiment of the present invention in detail by cooperating with FIGS. 4 to 6. The touch detection method is adapted for a display apparatus having a partial overlapped time in enable pulses of two adjacent gate lines.

Refer to FIG. 4, which illustrates a partial circuit diagram of a display apparatus 10 with a touch function in accordance with the exemplary embodiment of the present invention. As shown in FIG. 4, the display apparatus 10 includes a plurality of gate lines GL2n−1, GL2n and GL2n+1, a data line DL and a sense line SL. The data line DL is intersected with the gate lines GL2n−1, GL2n and GL2n+1, and a pixel (not marked in FIG. 4) is arranged at each intersecting location. Each pixel includes a thin film transistor (TFT) Q1, a storage capacitance Cst and a liquid crystal capacitance Clc. A drain electrode and a gate electrode of the TFT Q1 are electrically coupled to the data line DL and a corresponding one of the gate lines GL2n−1, GL2n and GL2n+1. The storage capacitance Cst and the liquid crystal capacitance Clc are coupled in parallel and are electrically coupled between a source electrode of the TFT Q1 and the common voltage Vcom. The gate line GL2n is adjacent to the gate lines GL2n−1 and GL2n+1, and is arranged between the gate lines GL2n−1 and GL2n+1. The gate line GL2n and the gate lines GL2n−1 and GL2n+1 are driven by a bilateral gate-on-array (GOA) circuit, and are enabled in sequence to turn on each pixel. The sense line SL is electrically coupled to the gate line GL2n, and is not electrically coupled to the gate lines GL2n−1 and GL2n+1. Specifically, the gate electrode of the TFT Q2 is electrically coupled to the gate line GL2n, the drain electrode of the TFT Q2 is electrically coupled to the sense line SL, and the source electrode of the TFT Q2 is electrically coupled to a sensor pad SP. Therein, the sensor pad SP is touched to be electrically coupled to the common voltage Vcom.

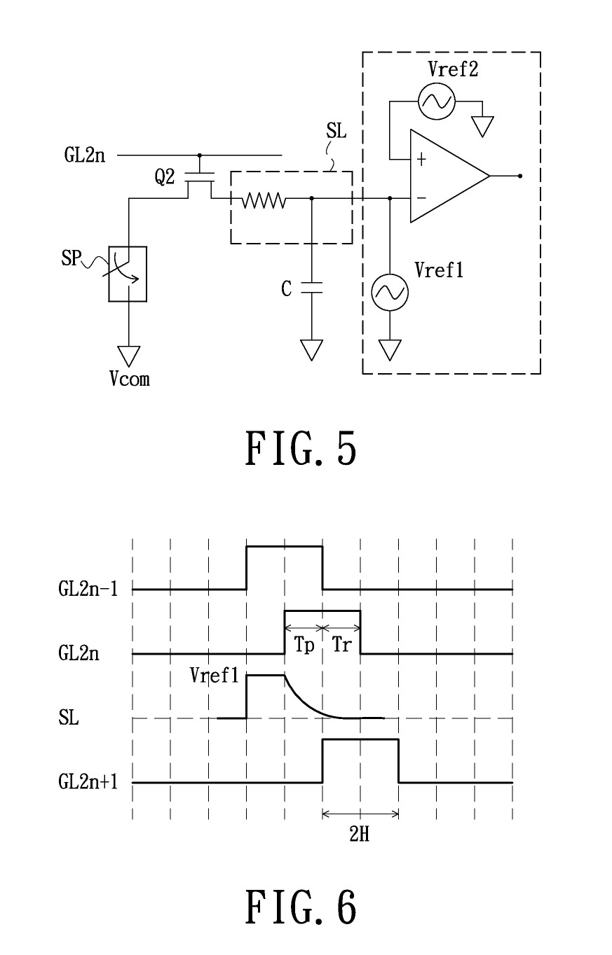

Refer to FIG. 5, which illustrates an equivalent-circuit diagram of the sense line SL and a detection circuit. A parasitic capacitance C is formed between the sense line SL and the common voltage Vcom. The detection circuit (not marked in FIG. 5) includes a comparator (not marked in FIG. 5), a reference supply Vref1 and another reference supply Vref2. The reference supply Vref1 is electrically coupled between a negative input terminal of the comparator and the common voltage Vcom, and the negative input terminal of the comparator is electrically coupled to the sense line SL. The reference supply Vref2 is electrically coupled between a positive input terminal of the comparator and the common voltage Vcom.

Refer to FIG. 6, which illustrates a timing chart of signals in the gate lines GL2n−1, GL2n and GL2n+1, and the sense line SL. As shown in FIG. 6, the gate lines GL2n−1, GL2n and GL2n+1 are enabled in sequence by performing a potential pull-up operation (of course, the gate lines GL2n−1, GL2n and GL2n+1 can be designed to be enabled by performing a potential pull-down operation according to different designs of circuits). Each enable period (that is an enable pulse width) for enabling each of the gate lines GL2n−1, GL2n and GL2n+1 is two scan line time (2H), and includes a pre-opening time Tp and a real-opening time Tr. The pre-opening time Tp is before the real-opening time Tr, and is equal to the real-opening time Tr. However, the pre-opening time Tp may be unequal to the real-opening time Tr based on actual needs. The enable periods for enabling two adjacent gate lines respectively overlap partially. Specifically, the real-opening time Tr of a previous gate line overlaps the pre-opening time Tp of a following gate line.

From FIG. 6 it can be seen that, the sense line SL is performed a charge operation in the pre-opening time Tp of the enable period for enabling the gate line GL2n−1. The reference supply Vref1 charges the sense line SL to the potential of Vref1. At the moment, the gate line GL2n electrically coupled to the sense line SL is not enabled. In other words, the charge operation to the sense line SL is performed in the enable period for enabling the gate line GL2n−1 and before the enable period for enabling the gate line GL2n. Since the gate line GL2n is still not enabled in charging the sense line SL, the sense line SL can still keep the potential of Vref1 even if the sensor pad (as shown in FIG. 5) is touched to be electrically coupled to the common voltage Vcom.

In addition, the sense line SL is performed a detection operation in the real-opening time Tr of the enable period for enabling the gate line GL2n−1, to detect whether the sensor pad is touched. At the moment, the gate line GL2n electrically coupled to the sense line SL is enabled, and the gate line GL2n+1 adjacent to the gate line GL2n is not enabled. In other words, the detection operation to the sense line SL is performed in the enable period for enabling the gate line GL2n and before changing statuses of the gate lines GL2n−1 and GL2n+1. If the sensor pad SP (as shown in FIG. 5) is touched to be electrically coupled to the common voltage Vcom at the moment, the sense line SL is discharged to achieve the potential of the common voltage Vcom. Since the potential of Vcom at the negative input terminal is less than the potential of Vref2 at the positive input terminal, the comparator of the detection circuit can detect the sensor pad SP is touched, to complete the touch detection operation.

In addition, although the above exemplary embodiment is charging the sense line by the reference supply and discharging the sense line when the sensor pad is touched, the sense line can be discharged by the reference supply and charged when the sensor pad is touched in practice, according to a variable design of the potential.

The above exemplary embodiment of the present invention perform the detection operation in the real-opening time Tr of the previous gate line GL2n−1 before the gate line GL2n electrically coupled to the sense line SL, and before the enable period for enabling the next gate line GL2n+1 thereafter, so as to perform the charging operation before the enable period for enabling the gate line GL2n correspondingly. Thus the charging operation to the sense line SL is not influenced by the touch operation. Therefore, the touch detection method of the above exemplary embodiment of the present invention can be adapted for a display apparatus having a partial overlapped time in the enable pulses of the two adjacent gate lines.

Furthermore, one skilled in the art also can suitably vary the touch detection method of the above exemplary embodiment of the present invention, such as suitably varying the configurations of the display apparatus, interchanging the electrical-connection relations of the source electrode and the drain electrode of each TFT, and/or the relation between the real-opening time and the pre-opening time of the enable pulse.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A touch detection method adapted for a display apparatus, the display apparatus comprising a first gate line, a sensor pad and a second gate line adjacent to the first gate line, the sensor pad being electrically coupled to the first gate line, the touch detection method comprising steps of:
enabling the first gate line; and
detecting whether the sensor pad is touched before enabling the second gate line;
wherein a subsequent enable period for enabling the second gate line and an enable period for enabling the first gate line are overlapped for a partial overlapped time.

2. The touch detection method as claimed in claim 1, wherein the partial overlapped time is a half of the enable period for enabling the first gate line.

3. The touch detection method as claimed in claim 1, wherein the enable period for enabling the first gate line comprises a pre-opening time and a real-opening time, the pre-opening time is before the real-opening time, and the step of detecting is performed in the pre-opening time of the enable period for enabling the first gate line.

4. The touch detection method as claimed in claim 3, wherein the pre-opening time is equal to the real-opening time.

5. The touch detection method as claimed in claim 1, wherein the first gate line is enabled by performing a potential pull-up operation.

6. The touch detection method as claimed in claim 1, wherein the first gate line is enabled by performing a potential pull-down operation.

7. A touch detection method adapted for a display apparatus, the display apparatus comprising a first gate line, a second gate line adjacent to the first gate line, and a sensor pad, the sensor pad being electrically coupled to the second gate line, the touch detection method comprising steps of:
enabling the first gate line and the second gate line in sequence, wherein an enable period for enabling the second gate line and another enable period for enabling the first gate line are overlapped for a partial overlapped time; and
detecting whether the sensor pad is touched in the partial overlapped time when both of the first gate line and the second gate line are enabled.

8. The touch detection method as claimed in claim 7, wherein the partial overlapped time is a half of the enable period for enabling the first gate line.

9. The touch detection method as claimed in claim 7, wherein the enable period for enabling the first gate line comprises a pre-opening time and a real-opening time, the pre-opening time is before the real-opening time, and the step of detecting is performed in the real-opening time of the enable period for enabling the first gate line.

10. The touch detection method as claimed in claim 9, wherein the pre-opening time is equal to the real-opening time.

11. The touch detection method as claimed in claim 7, wherein the second gate line is enabled by performing a potential pull-up operation.

12. The touch detection method as claimed in claim 7, wherein the second gate line is enabled by performing a potential pull-down operation.

13. A touch detection method adapted for a display apparatus, the display apparatus comprising a first gate line, a second gate line, a third gate line and a sense line, the second gate line being adjacent to the first gate line and the third gate line and being arranged between the first gate line and the third gate line, the sense line being electrically coupled to the second gate line and not electrically coupled to the first gate line and the third gate line, the touch detection method comprising steps of:
enabling the first gate line, the second gate line and the third gate line in sequence, wherein a first enable period for enabling the first gate line and a second enable period for enabling the second gate line are overlapped for a first partial overlapped time, and a third enable period for enabling the third gate line and the second enable period for enabling the second gate line are overlapped for a second partial overlapped time;
charging the sense line before the second enable period; and
detecting the sense line in the second enable period before enabling statuses of the first gate line and the third gate line being changed.

14. The touch detection method as claimed in claim 13, wherein the detection operation is performed in the first partial overlapped time when both of the second gate line and the first gate line are enabled.

15. The touch detection method as claimed in claim 13, wherein the detection operation is performed in the second enable period and before the third enable period.
